(19) United States
(12) Patent Application Publication
(10) Pub. No.: US 2011/0142993 A1
(43) Pub. Date: Jun. 16, 2011

(54) Method for Making Pet and Animal Comestibles

(76) Inventor: Timothy Bowser, Stillwater, OK (US)

(21) Appl. No.: 12/634,908

(22) Filed: Dec. 10, 2009

(51) Int. Cl. A23K 1/165; A23K 1/00; A23P 1/00

(52) U.S. Cl. 426/61

(57) ABSTRACT

A method for making chew products for pets and domesticated animals includes selecting raw ingredients from animal and plant sources. Offal is separated from ingredients, which are then combined to form a base or base materials. The base materials are uniformly saturated with a digestive enzyme or a mixture of digestive enzymes. Saturated base materials are then dewatered and transformed into shapes. The shapes are dehydrated at a low temperature to retain enzyme activity and to render a shelf-stable product.

### CROSS-REFERENCE TO RELATED APPLICATIONS

Not Applicable

### FEDERALLY SPONSORED RESEARCH

Not Applicable SEQUENCE LISTING OF PROGRAM

Not Applicable

### BACKGROUND OF THE INVENTION

1. Field of Invention

The present invention relates to pet and animal food processing, and in particular to a method and apparatus for making chews, treats and the like.

2. Background of the Invention

Animal and plant materials are frequently made into chew products (toys, treats, teeth cleaning devices, breath fresheners, medicine carriers and the like) for dogs, cats, other pets and domesticated animals. Heretofore, materials sourced from animals (skin, meat, fat, tissue, organs, etc.) and plant ingredients (like flour, bran, meal, oil, chlorophyll, mint, and gluten), were typically prepared by processes including cooking, forming, dehydration and molding. Common characteristics of the chew products include attractive flavor, aroma and size for the pet (and owner), durability, low cost, and stain free for the owner's clothing, home and household goods.

For example, U.S. Pat. No. 7,194,981 (2007) discloses a rawhide pet chew formed from processed, shaped and dried animal skin. A similar product is explained in U.S. Pat. No. 7,025,020 (2006), which discloses a pet chew formed using a dried and shaped pork skin with an outer layer surrounding a softer, meaty core material. U.S. Pat. No. 7,592,031 (2009) describes a dried pet food, which serves to mechanically clean the teeth of pets when chewed. U.S. Pat. No. 7,579,038 (2009) explains a thermoplastic, protein-based, edible molded pet chew that can act as a breath-freshener and teeth cleaner.

While such processes and products have proven quite effective, there are certain drawbacks associated with this technology. For example, dried meats and skins and some formed products are difficult or impossible to digest if swallowed completely or in large chunks or pieces. Mixtures of proteins and other ingredients, such as wheat gluten, may form insoluble products that are indigestible. Many pets and domesticated animals vigorously bite and tear at chew products removing pieces and chunks. The pieces and chunks may be inadvertently swallowed by the animal. Ingestion of chunks and pieces of these products can result in blockage of the animal's digestive system. Digestive system blockage may lead to severe pain and death. U.S. Pat. No. 6,186,096 (2001) discloses that certain pet chews can damage a dog by causing digestive problems when pieces are torn off the product and consumed.

PetSci, LLC, Stillwater, Okla., has completed extensive research on animal food digestibility. As a result of their research, they have developed and published tests to evaluate the digestibility of pet and animal chews and foods (Bowser, T. J. and C. I. Abramson, 2006. Low-cost in vitro Screening Method for Digestibility of Pet Chews. American Journal of Animal and Veterinary Sciences 1 (2): 23-26). In-vitro tests were performed using the referenced methods simulating the digestion of chew products in the canine intestinal tract. Results demonstrated that rawhide pieces cut from a commercial chew product (1×1 cm×native hide thickness of about 1.5 mm) digested less than 20% over a 10-hour period. The normal evacuation period for healthy animals is approximately 4 hours.

U.S. Pat. No. 2,988,045 (1961) teaches that rawhide is harmless to dogs and can be digested “in the manner of meat”. Several class action lawsuits (Greenies Dog Treat Maker Settles Class Action Lawsuit, Kansas City Star; Sep. 19, 2007; Pedigree Super Chew Dog Treat, At Susan Peters website http://hubpages.com/hub/Pedigree-Super-Chew-Dog-Treat-Healthy-Dog-Foods, accessed 8 Dec. 2009; and Vo-Toys Inc., Defective product or service, rawhide dog chews not safe, http://www.classadvocate.com/?gclid=CN2ao9bYx54CFQnxDAodhCUIrg#iDetail355-3, accessed 8 Dec. 2009) that were filed against large chew product manufacturers/distributors indicate that serious digestibility problems exist with some pet chew products.

Research and experience show that accidental ingestion of chunks or pieces of chew products may cause injury to pets and animals. U.S. Pat. No. 4,260,635 (1981) teaches the use of “animal-safely digestible structure” derived from animal tissue in pet chews. The “animal-safely digestible structure” is made by shredding, cutting, or otherwise reducing the size of animal tissue like cowhide, rawhide, tendons, and skin. It is explained that the reduced material yields collagen fibers, which can be molded into a pet chew to give it properties that increase “chew-life”. The classification of materials that are safe for digestion is an indication that some materials are not safe for digestion. The same patent confirms this idea as it teaches the use of cellulosic materials, which are a source of “animal safely-indigestible structure”. The pet cannot digest these fibers, but it is suggested that they can freely pass through the pet's digestive tract without causing harm. The cellulosic fibers are assumed to provide roughage, which can be an aid to digestion.

Both animal-safely digestible structure and animal-safely indigestible structure must be reduced in size by either mastication, digestion, or both, so that they can safely pass through an animal's digestive tract. It is obvious that mastication cannot be relied upon in cases when animals vigorously bite into and break off pieces and chunks of the product, which are quickly swallowed.

A means is needed to insure that proper size reduction takes place before swallowing pieces or chunks of chew products, or that the chew product degrades rapidly in the animal's digestive tract so that it can easily pass through. Many pet and animal owners will find it difficult and bothersome to monitor their pet to insure that proper size reduction takes place. Even when pets are monitored, it would be a tricky feat to intercept pieces and chunks of chew product before they are swallowed. My invention explains how enzymes can be incorporated into a pet chew product to aid digestion if pieces and chunks of the chew product are accidentally swallowed.

Enzymes have been used in chew products and animal feeds for many purposes including palatability, texture, shelf-life, dental cleaning, digestibility and odor reduction of excreta. Enzymes have not been added to a chew product before this invention to improve the safety and digestibility of pieces or chunks that may become accidentally lodged in the digestive tract of the animal.

Enzymes are added to dog foods to enhance palatability (U.S. Pat. No. 4,713,250; 1987) by pre-digestion of ingredients. Enzymes are typically inactivated by heat treatment after the desired reaction is complete. This process is especially common in the manufacture of dry dog foods.

U.S. Pat. No. 7,025,020 (2006) describes meat ingredients used for the soft inner core of a pet chew. The meat ingredients may be treated with enzymes to develop a liquid product with a softer texture. The enzymes are chemically or physically (heat) deactivated prior to forming into shaped cores for the treats. U.S. Pat. No. 5,928,690 (1999) also describes the use of an enzyme on meat ingredients to yield a puree with desirable textural properties of the meat ingredient and final product.

U.S. Pat. No. 4,540,585 (1985) describes the processing of a food product using heat without completely inactivating the enzyme so that the enzyme may affect the texture and palatability of the product after baking and during storage. Active enzymes present in the final product improve the shelf-life by extending the time that the texture remains acceptable.

U.S. Pat. No. 4,260,635 (1981) suggests the addition of certain enzymes to the product formulation to remove plaque from the animal's teeth. The enzymes attack the plaque attached to the animal's teeth. Example A of the same patent indicates the use of enzymes to prepare ground cowhide as an ingredient for incorporation into a pet chew. The purpose of the enzyme-treated, ground cowhide ingredient is to add structure and chew resistance to the dental product.

Enzymes have been added to ruminant feeds (U.S. Pat. No. 5,720,971; 1998) to increase digestibility by assisting the activity of microbes. The enzymes do not predigest or digest the feed materials themselves, but have a synergistic effect with the rumen bacteria. Another patent (U.S. Pat. No. 7,005,128; 2006) discloses the use of enzymes to increase digestibility in rumen feeds with the purpose of increasing the conversion of feed consumed relative to the weight gain of the animal.

Enzymes may be added to pet foods to help reduce odor of animal excreta as described in U.S. Pat. No. 6,162,470 (2000). The enzymes work in conjunction with other ingredients in the pet food to produce compounds that reduce odor.

Another drawback of existing processes used to manufacturer chew products is a lengthy and expensive dehydration period required to achieve the final product moisture level. Dehydration is slow because of the natural water-binding capabilities of the animal and plant materials and mixtures with other ingredients. Slow dehydration reduces the production rate and increases the amount of energy needed to manufacture the product. My invention reduces this problem by increasing the rate of dehydration of the chew product. My research has shown a significant reduction (up to 40%) in dehydration time for dried meats processed with enzymes (Bowser, T. J., R. S. Frazier, P. R. Weckler, S. J. Kowalski. 2009. Optimizing jerky drying time with minimal product impact. The Open Food Science Journal. V3: 79-83).

### SUMMARY OF THE INVENTION

The present invention provides a method of incorporating an enzyme or a mixture of enzymes into dry, wet, processed or unprocessed ingredients of pet chews and animal foods. The pet chew is processed so that the viability of the enzyme is maintained throughout the normal shelf-life of the product. Enzymes in the product are activated when they are wetted by fluids in the animal's digestive tract. This method enhances the digestibility of pet chews and animal foods. Enhanced digestibility is important when chunks or pieces of the product that could potentially block the animal's digestive tract are accidentally ingested. This method enhances the digestibility of product chunks or pieces that have been swallowed un-chewed, broken-off or under-chewed.

One aspect of the invention is to provide a method for treating ingredients that are used to manufacture pet foods, pet treats, chews and the like. Raw ingredients are selected. Hair, filth, bone chips, wood particles, stems and other offal are then separated from the ingredients to form a base. Base materials are mechanically treated to improve the infusion rate of digestive enzymes and to soften and shorten tissues. Digestive enzymes are infused into the base using injection and soaking methods. Soaking may include vacuum and tumbling or massaging to enhance enzyme uptake. The base materials are the fashioned into a product of the desired shape and then dehydrated under precise temperature-controlled conditions to preserve the efficacy of the digestive enzyme. The products are then packaged for shipping and retail sales.

Digestive enzymes are a critical component of the present invention. Particularly preferable examples thereof include enzymes capable of digesting materials as described above which are used as ingredients in pet chews and foods. Although arbitrary enzymes having the above-mentioned actions are usable in the present invention, it is efficacious to use, for example, bromelain, papain, ficin, pepsin, pancreatin, protease, amylase, cellulase, hemicellulase, xylanase, lactase, lipase, singly or in combination. The above-described enzymes or materials containing the same can be obtained by treating plants or animal materials containing enzymes by conventional methods. Products obtained by further processing these preparations are also usable in the present invention.

Another aspect of the present invention is to provide an apparatus for making pet foods, pet treats, chews and the like. Unwanted offal is separated from the ingredients by sifting, washing, sorting, skinning, floating, trimming or other methods. Mechanical treatment may be used to increase porosity, break and soften tissue fibers and shorten tissue fibers to prepare the raw ingredients to uptake and retain digestive enzymes. The ingredients are infused with digestive enzymes by injection and/or soaking in a tank containing enzymes and carrier liquids. Reduced pressure, chemical processing aids (like surfactants and buffers), agitation and controlled temperature are used to enhance the infusion process. After infusion, unused liquids are drained and reused or discarded. Further processing such as extrusion, blending, shaping and molding may be included to make particular products such as chews. Dehydration of the infused product is carried out under low-heat conditions to prevent inactivation of the digestive enzymes. The final product is then packaged for distribution and sale.

The principal objectives of the present invention are to provide a process and apparatus for making pet chew products and ingredients that can be rapidly digested in the animal's system, especially when chunks or pieces are swallowed. Active enzymes infused into the ingredients assist the digestive process when wetted. The manufacturing process is particularly efficient in use and economical to operate, because it reduces dehydration time and energy requirements.

These and other advantages of the invention will be further understood and appreciated by those skilled in the art by reference to the following written specification, claims and appended drawings.

### BRIEF DESCRIPTION OF THE DRAWINGS

FIG. 1 is a schematic view of a process and apparatus embodying the present invention.

### DETAILED DESCRIPTION OF THE PREFERRED EMBODIMENTS

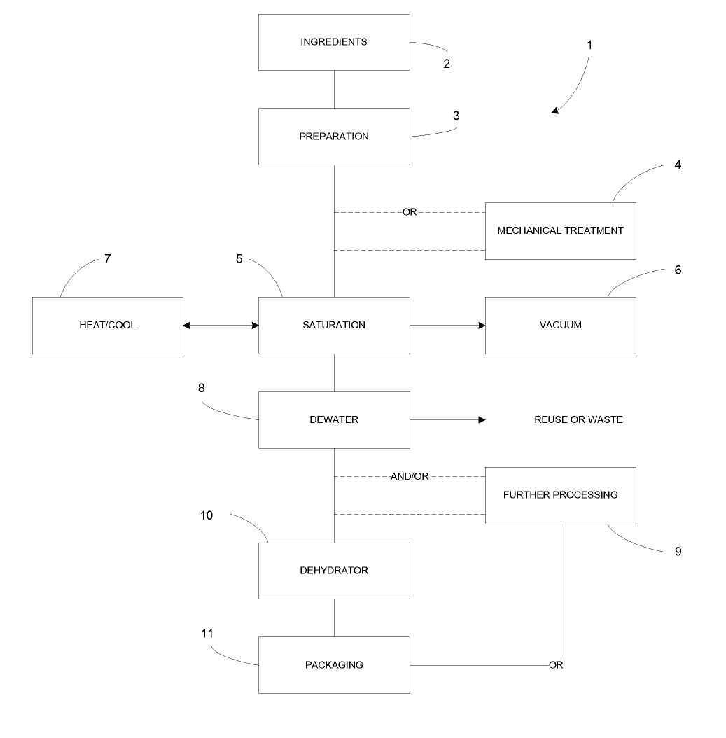

For purposes of description herein, the terms “upper”, “lower”, “right”, “left”, “rear”, “front”, “vertical”, “horizontal”, and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specifications are simply exemplary embodiments of the inventive concepts defined in the appended claims. Hence, specific dimensions, step sequences, processing parameters, and other physical characteristics relating to the embodiments disclosed herein are not to be considered as limiting unless the claims expressly state otherwise.

The reference numeral 1 (FIG. 1) generally designates an apparatus or system capable of practicing a method for making ingredients for or finished chew products embodying the present invention. The present invention contemplates ingredients 2, wherein raw ingredients of the type sourced from animals, plant and other sources are transported or collected for processing. Hair, filth, bones, stems, leaves and other offal are separated from the ingredients at a preparation station 3 to form a predetermined base that is transported to a saturation station 5, wherein the base is infused and or injected with a mixture of digestive enzymes. Vacuum 6, applied at the saturation station 5, temperature control 7, and agitation are used to improve the uniformity and speed of the infusion process. The infused base is transported to a dewatering station 8, where free water is removed from the same by vibratory screens, compressed air jets, centrifugation, pressure, or other dewatering method. Dewatered base is then dried in a dehydrator 10, that principally makes use of energy (heat) to remove sufficient water to render a shelf-stable product 11.

The apparatus and related process 1, illustrated in FIG. 1 are particularly adapted for use in the commercial manufacture of ingredients of the type used in pet foods, chew products, treats, and similar products. Unlike prior processing techniques, the present invention provides processing of ingredients to render them more digestible and results in improved manufacturing efficiencies.

In the illustrated example, the raw ingredients are selected in accordance with the type of pet treat or food desired, and typically includes animal and plant products like meat, skin, fat, tissue, organs, flour, gluten, bran, and oil. Preferably, all ingredients are initially cleaned at a preparation station 3, to remove debris, residue, unwanted materials and the like. Hides may be dehaired chemically or by hot water or combination Skin may be separated from meat, fat and tissue using a skinning machine like that produced by Townsend Engineering under the model designation 500. An optional mechanical treatment station 4, is provided if improved infusion rate of digestive enzymes, and/or softened and shortened tissues are desired.

A mechanical treatment station 4, prepares the materials for infusion of the digestive enzymes by softening and/or shortening ingredient tissues. In one example of the present invention, a meat tenderizer manufactured by Biro Manufacturing Company under model designation Pro-9, has been used to successfully practice the mechanical treatment step. In another example of the present invention, a meat tenderizer manufactured by the Jaccard Corporation under model designation E93, has been used to successfully practice the mechanical treatment step.

The prepared raw ingredients, or base, is then conveyed or transported to, and processed in a saturation station 5, wherein the base is uniformly infused with digestive enzymes at controlled temperature and pressure. Digestive enzymes can be combined with carrier liquid for saturation. In one example of the present invention, a rotating, temperature-controlled vacuum tumbler of the type manufactured by Koch Equipment under model designation GPS 1250, has been used to successfully practice the saturation step. In another example of the present invention, an injection system of the type manufactured by Koch Equipment under model designation Injectamatic P152 has been used to successfully practice the saturation step by injecting enzymes and carrier liquids into the base.

Preferably, a substance is added to the carrier liquids to aid enzyme infusion. In one example of the present invention, Tween 80 (monooleate), a food-grade surfactant, is added to the enzyme carrier liquid at the saturation station 5. A surfactant assists in reducing the surface tension of a liquid, enabling it to penetrate the base more rapidly and thoroughly.

The base is then preferably transported to a dewatering station 8, which serves to ensure complete removal of free water from the base. In one example of the present invention, the base is transported from the saturation station 5, to the dewatering unit 8, by an Iso-Flo dewatering shaker conveyor model 3672 manufactured by Key Technology, which also acts as a dewatering device. In one working embodiment of the present invention, a centrifugal dewatering device 8, comprises a Basket Dryer, manufactured by Key Technology under part number designation 840151.

Base materials that do not conform to the predetermined final shape or consistency after dewatering 8 are transported to further processing 9, where the base materials are mechanically transformed to the desired shape or consistency. In one working example, rawhide base is layered, cut and wrapped by hand or mechanically pressed into forms. In another working example, protein base is mixed with rice gluten and other ingredients to form a liquid base matrix that is molded into shapes. In another example of the present invention, the base matrix is molded into patty shapes by a fully automatic patty forming machine model Planus manufactured by the Jaccard Corporation.

After the dewatering step 8, and any further processing step 9, the base materials are transported to the dehydrator, 10 wherein the base materials are heated to a uniform temperature in the range of 100 to 150 degrees Fahrenheit. Ingredients are heated until the moisture is reduced sufficiently to render a shelf-stable product, generally with a water activity of less than 20%. Moisture-laden air is exhausted from the dehydrator and fresh makeup air is heated and added to the dehydrator to continue the drying process. Uniformity and accuracy of drying temperature prevents infused digestive enzymes from becoming inactivated. Dehydration proceeds more rapidly than prior techniques because the enzymes and mechanical treatments serve to reduce drying time by reducing the water holding capability of the base materials and increasing the pathways for water to travel through the base matrix.

After the base materials are dehydrated, they constitute a final product, which is cooled and packaged for retail sale and distribution 11. In one working example of packaging equipment, the product is wrapped in a shrink-fit plastic package using a Shanklin model F1 shrink wrapper. Some products may be sufficiently shelf stable after further processing so as not to require dehydration and may be packaged 11 directly after further processing 9.

By taking the pet chew products, toys, dental products, etc., containing the enzymes as specified in the present invention, the digestibility is be improved significantly. Namely, the present invention makes it possible to set free owners of domestic or pet animals and the animals themselves from the dangers of digestive system blockage from chunks and pieces of chews and feeds that have been accidentally ingested, achieving a highly recommendatory effect and perhaps saving the life of the animal. In addition, the presence of the enzyme may make the processing of the pet chew or treat less energy intensive and more rapid, which makes the present invention further effective.

In the foregoing description, it will be readily appreciated by those skilled in the art that modifications may be made to the invention, without departing from the concepts disclosed herein. Such modifications are to be considered as included in the following claims, unless these claims by their language expressly state otherwise.
The present invention will be described in greater detail by reference to the following Examples, but it should be understood that the invention is not construed as being limited thereto.

### Example 1

### Rawhide Chew

a) Preparation of chew product ingredient: Cut rawhide that has been commercially prepared for pet products into 1×1 cm pieces. Choose squares of uniform thickness and soak in pure water to rehydrate until soft.
b) Preparation of enzyme ingredient: 10% by weight of papain powder is dissolved in pure water at room temperature.
c) Infusing enzyme into pet chew material: Soak the rehydrated rawhide squares in the enzyme preparation at room temperature for 4 hours.
d) Dehydration of soaked pet chew: Remove rawhide squares from the enzyme preparation and dehydrate in a forced-air oven at 120 F.
e) Testing of digestibility: Test digestibility of the enzyme-treated rawhide squares and untreated rawhide squares for comparison in artificial canine intestinal juices according to method of Bowser et al. described above. Results of step (e) are shown in table 1.

TABLE 1
Results of digestibility test of rawhide squares
in artificial canine intestinal juices.

| | Untreated | Enzyme treated |
|---|---|---|
| Time in | rawhide squares | rawhide squares |
| digestive | % digested (average | % digested (average |
| juices, hours | of three samples) | of three samples) |
| 2 | 22.4 | 26.6 |
| 4 | 17.5 | 32.6 |
| 6 | 19.7 | 57.4 |

### Example 2

### Fillet of Duck Breast Jerky

a) Preparation of chew product ingredient: Cut pieces of commercially prepared fillet of duck breast jerky into 1×1 cm squares. Choose squares of uniform thickness and soak in pure water to rehydrate until soft.
b) Preparation of enzyme ingredient: 10% by weight of bromelain powder is dissolved in pure water at room temperature.
c) Infusing enzyme into pet chew material: Soak the rehydrated duck fillet squares in the enzyme preparation at room temperature for 4 hours.
d) Dehydration of soaked pet chew: Remove duck fillet squares from the enzyme preparation and dehydrate in a forced-air oven at 120 F.
e) Testing of digestibility: Test digestibility of the enzyme-treated duck fillet squares and untreated rawhide squares for comparison in artificial canine intestinal juices according to method of Bowser et al. described above. Results of step (e) are shown in table 2.

TABLE 2
Results of digestibility test of duck fillet squares
in artificial canine intestinal juices.

| | Untreated duck | Enzyme treated duck |
|---|---|---|
| Time in | fillet squares | fillet squares |
| digestive | % digested (average | % digested (average |
| juices, hours | of three samples) | of three samples) |
| 2 | 17.6 | 33.5 |
| 4 | 23.6 | 51.8 |
| 6 | 28.6 | 64.6 |

What is claimed is:

1. A method for making ingredients for pet or animal chew products in a batch or continuous process, comprising:
selecting raw ingredients having filth and unwanted portions like hair, leaves, stems, seeds and bone chips, to make a predetermined base;
preparing said base by cleaning and separating out said filth and unwanted portions;
saturating digestive enzymes into said base;
forming said base into product shapes; and
processing said product shapes to shelf-stable products that contain said enzymes, whereby said enzymes can aid in digestion of pieces or chunks of said products when consumed.

2. A method as set forth in claim 1, including:
adding processing aids such as surfactants and buffers to said digestive enzyme mixture prior to the saturating step.

3. A method as set forth in claim 2, including:
cleaning and sorting said base prior to said saturating step.

4. A method as set forth in claim 3, including:
treating said base by mechanical or chemical means for causing said base to rapidly saturate with said enzymes.

5. A method as set forth in claim 4, including:
controlling means for pressure and temperature of said saturating step for causing infusion of said enzymes into said base.

6. A method as set forth in claim 5, including:
agitating means of materials in said saturating step for causing infusion of said enzymes into said base.

7. A method as set forth in claim 6, wherein:
said saturation step includes an injection means for causing said enzymes to infuse into said base materials.

8. A method as set forth in claim 7, including:
removing free water and said saturation liquids from said base prior to said processing step.

9. A method as set forth in claim 8, wherein:
said saturation liquids are recycled back to said saturating step.

10. A method as set forth in claim 9, including:
forming said base by shaping means such as extruding, forming, cutting, layering, molding and pressing into predetermined shapes.

11. A method as set forth in claim 10, wherein:
said processing step comprises drying of said base to cause it to reach a shelf-stable water activity.

12. A method as set forth in claim 11, wherein:
said processing step comprises raising the temperature of said base to no higher than 10 degrees Fahrenheit (a temperature safety factor) less than the inactivation temperature of the most temperature-sensitive said enzyme infused into said product.

13. A method as set forth in claim 1, including:
adding processing aids such as surfactants and buffers to said digestive enzyme mixture prior to the saturating step.

14. A method as set forth in claim 1, including:
cleaning and sorting said base prior to said saturating step.

15. A method as set forth in claim 1, including:
treating said base by mechanical or chemical means for causing said base to rapidly and thoroughly saturate with said enzymes.

16. A method as set forth in claim 1, including:
controlling means for pressure and temperature of said saturating step for causing infusion of said enzymes into said base.

17. A method as set forth in claim 1, including:
agitating means of materials in said saturating step for causing infusion of said enzymes into said base.

18. A method as set forth in claim 1, wherein:
said saturation step includes an injection means for causing said enzymes to infuse into said base materials.

19. A method as set forth in claim 1, including:
removing free water and said saturation liquids from said base prior to said processing step.

20. A method as set forth in claim 1, wherein:
said saturation liquids are recycled back to said saturating step.

21. A method as set forth in claim 9, including:
forming said base by shaping means such as extruding, forming, cutting, layering, molding and pressing into predetermined shapes.

22. A method as set forth in claim 1, wherein:
said processing step comprises drying of said base to cause it to reach a shelf-stable water activity.

23. A method as set forth in claim 1, wherein:
said processing step comprises raising the temperature of said base to no higher than 10 degrees Fahrenheit (a temperature safety factor) less than the inactivation temperature of the most temperature-sensitive said enzyme infused into said product.

24. A method for preparing ingredients used in pet and animal chew products, treats, and foods in a batch or continuous process, comprising:
selecting at least one type of raw ingredient from a group consisting of animal and agricultural materials to make a predetermined base;
applying separation operations to remove offal from said base;
mechanically softening, shortening or tenderizing said base tissues;
saturating digestive enzymes uniformly into said base;
removing and recycling free enzymes and carrier liquids from said base;
shaping said base materials by shaping means such as pressing, injecting, forming, layering and cutting into predetermined forms; and
dehydrating said forms to a shelf-stable product containing active digestive enzymes, whereby said enzymes can aid in digestion of pieces or chunks of said product when consumed.
